(19) United States
(12) Patent Application Publication
(10) Pub. No.: US 2011/0133443 A1
(43) Pub. Date: Jun. 9, 2011

(54) COMBINATION SYSTEM OF VARIABLE PASSWORDS

(76) Inventor: Luis Henrique Duraes Silva, Montes Claros - MG (BR)

(21) Appl. No.: 12/089,799

(22) PCT Filed: Oct. 9, 2006
(86) PCT No.: PCT/BR2006/000210

§ 371 Date: May 14, 2008

(30) Foreign Application Priority Data
Oct. 10, 2005 (BR) PI 0504384-0

(51) Int. Cl. B42D 15/10

(52) U.S. Cl. 283/72

(57) ABSTRACT

The combination system of variable passwords has for purpose to become inviolable the access passwords to systems, when making possible the generation of variable passwords indefinitely, increasing the difficulty of criminal access significantly to the encryption codes of the operating systems managers o commercial or not commercial transactions that demand supply of passwords, offering extremely safety to those systems. The said system is constituted basically by a card (1), electronic or not, containing a graphic table (2) composed by characters or symbols disposed in groups of holes (4) or other types of leaks for selective reading of groups o characters or constant symbols of the printed table in the card, configuring, like this, different passwords (5) (6) for each operation to be executed through this combination system of variable passwords.

The present patent refers to a COMBINATION SYSTEM OF VARIABLE PASSWORDS, managed by an operating system especially developed for its use, which works through the united operation of cards, electronic or not, printed with random tables of characters or symbols associated to the detached and enclosed forms physically compatible with those tables, which has the property of generating variable passwords in order to become the financial operations or other operations, electronics or not, inviolable, demanding the supply of passwords.

Nowadays, safety systems used in the transactions and operations that it demands passwords are extremely vulnerable to the criminal access for third parties, because they make use of fixed passwords with combinations that stay invariable along successive operations, which favors the decryption of their access passwords and become those old protection systems little reliable and easily violated, due to the readiness that those fixed and invariable passwords offer along its time of validity, mainly if we consider the existence of software and other mechanisms specialized in decryption of passwords.

With the intention of to correct such deficiency and to become the passwords of the cards used in financial operations and other operations definitively undecipherable and to impede the criminal action of third parties, it was developed the present COMBINATION SYSTEM OF VARIABLE PASSWORDS that consists, fundamentally, in the use of a card printed with a graphic table of symbols or characters, disposed in a certain geometric composition, working together to a detached and enclosed form with industrial drawing physically compatible with the referred table, assembly that creates a system with the property of generating different passwords to assist to each new requested operation through the referred card, by the positioning of the referred form on certain areas of the table printed in this card, in order to select groups of characters or of symbols that will always constitute a new password, making possible an extensive variation of combinations, which means passwords for the same card, forcing, in theory, the use of a new password for each new operation, which become the access no authorized to those combinations virtually impossible, due to the fact that the encryption of the access passwords of this new system becomes extremely complex for obeying to a random order, providing therefore more protection and safety for the users of the cards and inhibiting the criminal action of third parties, once it demonstrates that any attempts of violation are extremely unviable, due to the improbability to forecast the subsequent passwords to be requested by the operation headquarters that uses this COMBINATION SYSTEM OF VARIABLE PASSWORDS.

The said system can be constituted, as a simple example, by a card, electronic or not, printed with a graphic table generated in a random order disposed vertically or horizontally, in columns or lines, or still in another geometric disposition, this table can be constituted by numbers or letters of any languages or for other characters, symbols or drawings, in the most several ways, or still for any other graphic signs, since the used forms find correspondence or compatibility to the characters and symbols of the keyboards of the operating system terminals to the card is submitted, this card should be operated jointly to a form, which should be a detached graphic piece and fixed to the card, and compatible with the referred printed table, containing leak or cuts, holes or tears, transparent or translucent areas or any other type of physical interference that allow to select and to visualize through itself a certain group of graphic signs of the referred table, to the juxtapose the form on it, being able to, as much the card as its detached and enclosed form, to have models of industrial drawing, dimensions and formats the most several possible, and to be produced in plastic, paper, cardboard, metal or any available materials in the market, since they work jointly and be appropriate to the operational patterns demanded by the current law or already used in the specific communities in that this new S COMBINATION SYSTEM OF VARIABLE PASSWORDS be implanted.

The system will be better understood through the following detailed description, in consonance with the enclosed figures, where:

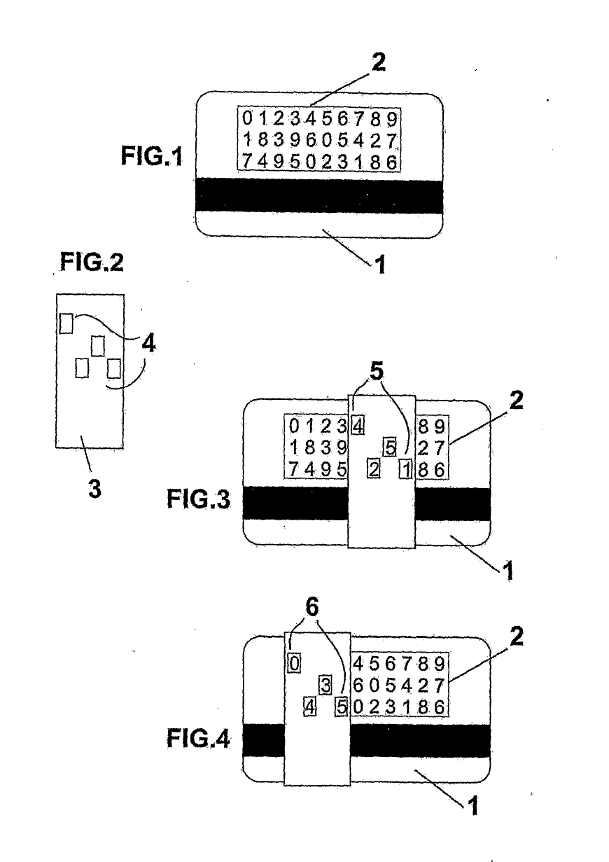

The FIG. 1 represents a standard card, electronic or not, printed, in this case, with a numeric graphic table.

The FIG. 2 represents a form containing holes for selective visualization of a group of characters or symbols.

The FIG. 3 represents the same card printed with the same numeric table being put upon by a detached form that reveals a group of numeric characters or password through their holes of selective visualization.

The FIG. 4 represents the same card being put upon by the same detached form in another area of the printed table and revealing other group of numeric characters through their holes of selective visualization.

With reference to the those figures, it can be observed, as one of the countless options of configuration of the COMBINATION SYSTEM OF VARIABLE PASSWORDS, a card (1), electronic or not, with graphic impression of a table (2) composed of three series of numbers from 0 to 9 distributed accidentally and a basic model of detached form (3) containing a group of holes for selective visualization (4).

In the following figure, it can be observed a simulation of the COMBINATION SYSTEM OF VARIABLE PASSWORDS operation, where, for the execution of an operation, the same detached form (3) was positioned on the table (2) of the card (1), revealing, through the holes, a group of numbers (5), which will correspond to the new password that the user of the card should supply to the operating system to execute the wanted operation.

And still, in the last figure, simulating a new operation with the same card, we can observe the same detached form (3) positioned on other area of the table (2) of the same card (1), revealing, through the holes, a group of different numbers (6), which will correspond to the new password that the user of the card should supply to the operating system to execute another operation.

Therefore, being used of this new COMBINATION SYSTEM OF VARIABLE PASSWORDS, composed by a printed card with table of associated characters to a form of selective reading, just as it was demonstrated above, the headquarters of operations will request to the user the due juxtaposition of the form on certain area of the printed table in the card, so that the group of holes recorded in the form demonstrates, in the case of the present example, a group of numeric characters, characters that will correspond to the password that the user should supply to the system in order to have access to the requested operation, and so forth, in other words, to each new operation application done by the user, the operating system will request a new positioning of the form on different areas of the printed table in the card and the due supply of the found combinations, in other words, it will request so many passwords how many the operations are requested by the user of the card.

Basing on the examples above described, it is concluded by the innovation of the COMBINATION SYSTEM OF VARIABLE PASSWORDS in what refers to systems of safety that demands passwords for the execution of operations and transactions with the use of cards, be them electronic or not, because of the application of an exclusive and differentiated paradigm that proposes the variation of the passwords of a same card, since the cards configured with the new COMBINATION SYSTEM OF VARIABLE PASSWORDS will work with passwords of different combinations to each requested operation, surpassing, like this, the old systems of configuration of fixed passwords, introducing a dynamic mechanism of random generation of variable passwords, where the combinations start to be unexpected and extremely unavailable to the criminal violation by third parties, be by human or technological means, establishing a method extremely effective, simple, practical and absolutely original of protection for the password cryptography, which, we emphasized, it checks to the COMBINATION SYSTEM OF VARIABLE PASSWORDS the character of innovation, for which the present patent of invention is requested.

1. “COMBINATION SYSTEM OF VARIABLE PASSWORDS”, characterized by comprising in its essence the use, conjugated or not, of a card (1), electronic or not, printed with a table (2), composed by symbols or characters disposed geometrically in random order or not, and of a detached and enclosed form (3) containing one or more groups of leaks or holes (4) for selective visualization and reading, form that, juxtaposed on certain areas of the referred printed table in the card, will allow the reading of a selected group of characters or symbols that will correspond to variable passwords necessary to the execution of operations managed by operating systems, electronic or not, that base on the use of cards, electronic or not, by the supply of access passwords, being able to, as much the card as its detached and enclosed form, to have models of industrial drawing, dimensions and formats the most several possible and be made with cuts of special graphic knives the most varied possible, besides they could be produced in plastic, paper, card, metal or in any material available in the market, since they work jointly and be appropriate to the operational patterns demanded by the current law or already used in the specific communities in that this new system be implanted.

2. “COMBINATION SYSTEM OF VARIABLE PASSWORDS”, characterized by comprising in its essence the use, conjugated or not, of one or more cards (1), electronic or not, virtual or physical, that contains tables (2) composed by symbols or characters disposed in random order or not, with the purpose of generating variable passwords through combinations between them in order to execute operations through operating systems, electronic or not, that demand the supply of access passwords and that base on the use of cards, electronic or not, virtual or physical.

3. “COMBINATION SYSTEM OF VARIABLE PASSWORDS”, characterized by comprising in its essence the use of forms (3) that contain groups of demarcations, cuts, transparency or other type of leaks destined to the reading or combination of tables, be in combination with physical printed pieces or through digital systems, monitors or others finish electronic, with the purpose of generating variable passwords for execution of operations in systems that demand supply of passwords.
